(19) United States
(12) Patent Application Publication
(10) Pub. No.: US 2026/0228102 A1
(43) Pub. Date: Aug. 6, 2026

(54) Automated Reasoning and Explanation of Correlated Factors in Digital Experience Monitoring

(71) Applicant: Zscaler, Inc., San Jose, CA (US)

(72) Inventors: Prasannakumar Jobigenahally Malleshaiah, San Jose, CA (US); Hanchen Xiong, London (GB); Ashok Kolachina, Milpitas, CA (US); Anirudh Achanta, San Jose, CA (US); Jay Makwana, Burnaby (CA); Claudionor Jose Nunes Coelho, JR., San Jose, CA (US); Sudipto Guha, San Jose, CA (US); Prakash Jagatheesan, San Jose (CA); Shreyas Madapura Chandraiah, San Jose, CA (US); Darshan Dhanaraj, Bangalore (IN); Srinivas Tummala, San Jose, CA (US)

(73) Assignee: Zscaler, Inc., San Jose, CA (US)

(21) Appl. No.: 19/085,276

(22) Filed: Mar. 20, 2025

(30) Foreign Application Priority Data
Feb. 3, 2025 (IN) 202541008686

(51) Int. Cl. G06F 11/34

(52) U.S. Cl. CPC G06F 11/3409

(57) ABSTRACT

Systems and methods for automated reasoning and explanation of correlated factors in digital experience monitoring include collecting performance data from a plurality of sources, the performance metrics including network metrics, application performance metrics, device metrics, and user behavior metrics; identifying one or more anomalies and correlations between the collected performance data; processing the one or more anomalies and correlations with a Large Language Model (LLM) to generate one or more explanations for the identified anomalies and correlations; and presenting the generated explanations through a user interface.

### FIELD OF THE DISCLOSURE

The present disclosure generally relates to network and cloud security. More particularly, the present disclosure relates to systems and methods for automated reasoning and explanation of correlated factors in digital experience monitoring.

### BACKGROUND OF THE DISCLOSURE

Digital experience monitoring has become essential in modern IT environments as organizations increasingly rely on cloud-based applications, distributed networks, and remote workforces. Ensuring seamless user experiences is critical, yet the complexity of today's network and application landscapes makes it challenging for administrators to identify and resolve performance issues. Traditional monitoring tools often provide fragmented insights, focusing on isolated components such as endpoints, networks, or application servers. As a result, IT teams lack end-to-end visibility, making it difficult to pinpoint the root cause of disruptions. Network latency, application downtime, or device-level problems can all contribute to poor user experiences, but without correlated data across these domains, administrators are left guessing, leading to delayed issue resolution and increased user frustration. This underscores the need for a unified solution that can holistically monitor, measure, and troubleshoot digital experiences across all components of the service delivery chain.

### BRIEF SUMMARY OF THE DISCLOSURE

The present disclosure relates to systems and methods for automated reasoning and explanation of correlated factors in digital experience monitoring. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include collecting performance data from a plurality of sources, the performance metrics including network metrics, application performance metrics, device metrics, and user behavior metrics; identifying one or more anomalies and correlations between the collected performance data; processing the one or more anomalies and correlations with a Large Language Model (LLM) to generate one or more explanations for the identified anomalies and correlations; and presenting the generated explanations through a user interface.

The steps can further include wherein collecting performance data includes collecting real-time performance data. The performance data can be collected from any of the cloud-based system, endpoint devices, and applications. The LLM can be trained on a dataset that includes both general information and domain-specific technical data. The steps can include generating a prompt based on the one or more anomalies and correlations. The prompt can include a static portion and a dynamic portion, wherein the dynamic portion is automatically populated based on the one or more anomalies and correlations. The steps can include receiving user feedback on the generated explanations and using the feedback to refine the LLM.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a diagram of a cloud-based digital experience monitoring system.

FIG. 6 is a flowchart of a process for automated reasoning and explanation of correlated factors in digital experience monitoring.

### DETAILED DESCRIPTION OF THE DISCLOSURE

Again, the present disclosure relates to systems and methods for automated reasoning and explanation of correlated factors in digital experience monitoring. The system is designed to enhance the analysis and understanding of user experience metrics in digital environments. It includes several key modules including a data collection module that gathers performance data from various sources such as network metrics, application performance metrics, device metrics, and user behavior metrics, a correlation detection module that utilizes advanced machine learning algorithms to identify significant correlations within the collected data, an integration module that feeds these correlations into a Large Language Model (LLM), and an LLM processing module that generates coherent explanations for the identified correlations based on its extensive training on both general and domain-specific data. The system presents these explanations through a user-friendly interface, which includes visual tools like dashboards and charts for better comprehension. Additionally, a feedback mechanism allows users to provide input on the generated explanations, enabling continuous refinement and improvement of the system's reasoning capabilities. This automated approach ensures scalable, consistent, and expert-level insights into digital experience monitoring, significantly reducing the need for manual intervention.

### § 1.0 Cybersecurity Monitoring and Protection Examples

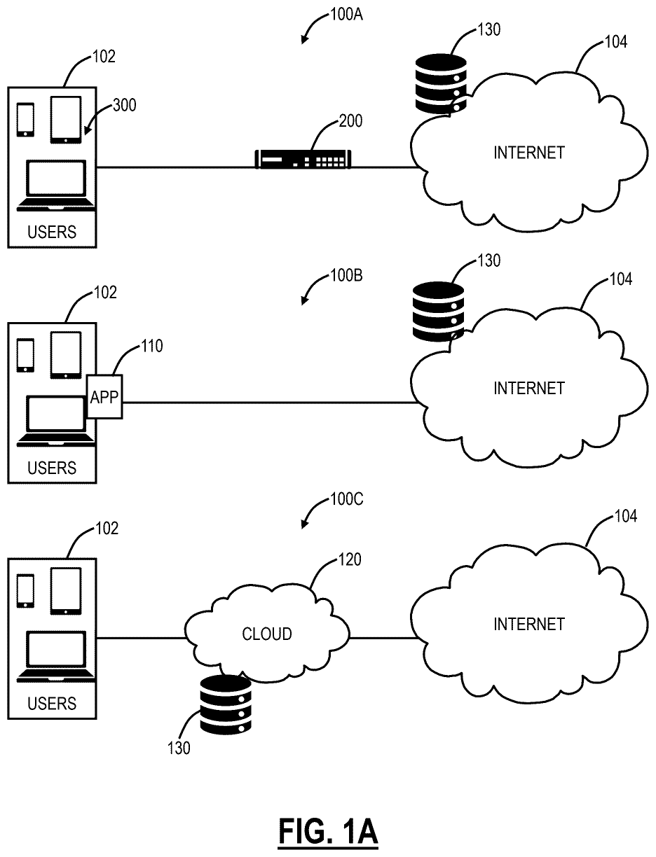

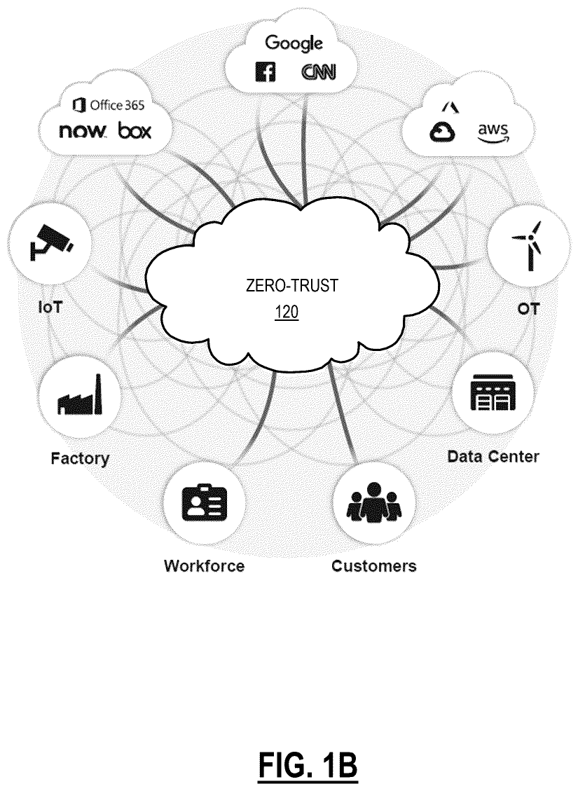

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

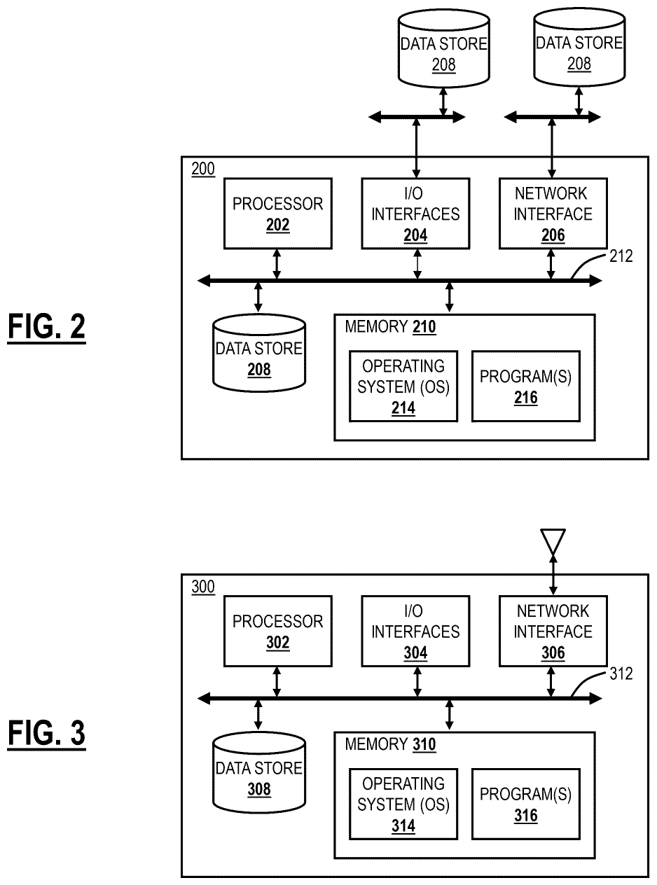

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an agent application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

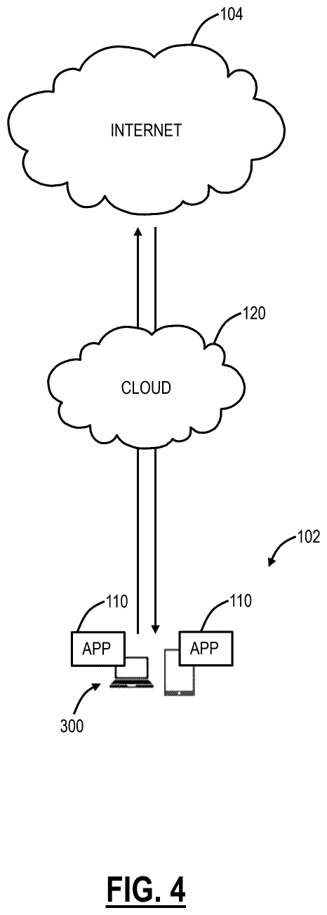

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Digital Experience Monitoring

Zscaler Digital Experience (ZDX), i.e., the digital experience monitoring system of the cloud 120, is an advanced solution designed to monitor and optimize user experience in digital environments by providing comprehensive visibility into the performance of applications, networks, and endpoints. By continuously gathering and analyzing performance data, the digital experience monitoring system helps IT teams proactively identify and resolve issues, ensuring seamless and efficient user interactions with business-critical applications.

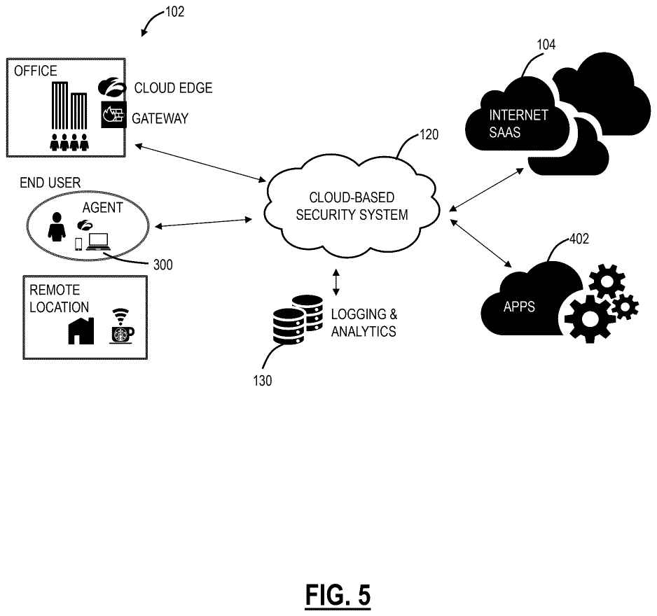

FIG. 5 is a diagram of a cloud-based digital experience monitoring system. The digital experience monitoring system operates by collecting performance data from various sources, including user endpoint devices/computing devices 300, the cloud 120 infrastructure, the internet 104, and destination applications 402. This data is then analyzed to generate digital experience scores, which reflect the quality of the overall user experience.

Agent applications 110 installed on user endpoint devices 300 collect detailed performance metrics such as network latency, packet loss, jitter, application response times, and device health indicators. The cloud 120 infrastructure monitors traffic between users 102 and applications 402, capturing performance data related to network conditions, node performance, and application availability. The digital experience monitoring system also integrates with application performance monitoring tools to gather data from the applications themselves, providing an inside-out view of application performance.

The performance data collected from endpoints 300, the cloud 120, and applications 402 are aggregated into a centralized analytics platform. This comprehensive data aggregation ensures a holistic view of the entire digital experience. The aggregated data is analyzed based on various performance metrics, such as network latency, packet loss, jitter, DNS resolution time, and application response time. The analysis correlates performance issues with potential root causes, identifying whether problems originate from the endpoint, network, or application layers. The digital experience monitoring system calculates digital experience scores based on the analyzed performance data. These scores are typically presented on a scale (e.g., 0 to 100), with higher scores indicating better user experience. The scoring considers multiple factors to provide a comprehensive assessment of user experience quality.

The digital experience monitoring system provides detailed dashboards and reports that visualize the digital experience scores along with the underlying performance metrics. These visualizations help IT teams quickly identify trends, anomalies, and areas needing attention. Further, the digital experience monitoring system can generate alerts and notifications when performance thresholds are breached, enabling proactive problem resolution.

In order to function, the digital experience monitoring system includes and utilizes components of the cloud 120. These components include agent applications 110 installed on endpoint devices 300 that collect and send performance data to the cloud 120. It provides visibility into the user's device performance, including network conditions and application usage. Nodes of the cloud 120 are distributed globally and act as enforcement points for traffic inspection and policy application. They monitor and log network performance data, such as latency and packet loss, as traffic passes through. A control plane manages policy configuration, user authentication, and overall service orchestration. It aggregates performance data from nodes of the cloud 120 and agent applications 110, ensuring that all collected metrics are stored and processed centrally. Finally, an analytics and AI engine is responsible for analyzing the aggregated data using machine learning algorithms and advanced analytics to derive insights and calculate digital experience scores. It correlates performance issues across different segments and identifies potential root causes.

The benefits of the digital experience monitoring system include enhanced user experience through proactive monitoring and resolution of performance issues, comprehensive visibility into application performance, network conditions, and endpoint health, proactive problem resolution with real-time alerts and detailed performance insights, and informed decision-making enabled by detailed reports and dashboards.

In conclusion, the digital experience monitoring system is a powerful tool that leverages agent applications 110, the cloud 120 infrastructure, and advanced analytics to measure and enhance digital experiences. By collecting, aggregating, and analyzing performance data, the digital experience monitoring system provides comprehensive visibility and actionable insights, enabling IT teams to deliver a superior digital experience to users. This innovative solution not only streamlines the process of performance monitoring and optimization but also ensures that organizations can maintain high levels of user satisfaction and productivity in an increasingly digital world.

As described scores are calculated for specific users 102, devices 300, etc. Digital experience scores are a comprehensive metric used to evaluate the quality of a user's interaction with digital applications and services. These scores provide a quantifiable measure of user experience by analyzing a variety of performance metrics. The foundation of digital experience score calculation is the collection of extensive performance data from multiple sources. This data typically includes network metrics such as latency, packet loss, jitter, and throughput; application performance metrics like application response times, page load times, and error rates; device metrics encompassing CPU usage, memory usage, battery health, and other device-specific performance indicators and user behavior metrics that provide insights into user interactions, such as session duration, click rates, and navigation patterns.

Once the data is collected, it is aggregated into a centralized analytics platform. This platform consolidates the information from the various sources to provide a holistic view of the user's digital experience. The aggregation process ensures that all relevant data points are considered in the analysis, allowing for a comprehensive assessment.

To ensure comparability across different metrics and data sources, the collected data is normalized. This involves adjusting the data to a common scale or format. For example, network latency might be measured in milliseconds, while CPU usage is measured as a percentage. Normalization converts these metrics into a standardized format, facilitating accurate comparisons and analyses.

The normalized data is then analyzed using sophisticated methods to assess various performance metrics. This analysis typically includes statistical analysis to identify patterns, trends, and anomalies in the data; time series analysis to examine how performance metrics change over time and detect temporal patterns; and correlation analysis to determine relationships between different metrics, such as how network latency may impact application response times.

Different performance metrics are assigned weights based on their relative importance to the overall user experience. These weights are determined through a combination of industry standards, expert knowledge, and empirical analysis. For example, application response time might be given more weight than CPU usage because it having a more direct impact on user experience. The weighted metrics are then combined to calculate an overall digital experience score. This score is usually presented on a scale (e.g., 0 to 100), with higher scores indicating better user experience.

To provide timely insights, digital experience scores are often calculated in real-time. This involves continuously collecting and analyzing performance data, and updating the scores as new data becomes available. Real-time calculation ensures that the scores reflect the current state of the user experience, allowing for immediate detection and resolution of issues.

The calculated digital experience scores are presented to users through intuitive dashboards and detailed reports. These visualizations help IT teams quickly understand the overall user experience and identify specific areas that need attention. Common visualization tools include scorecards, which summarize the overall digital experience score and key metrics; trend charts, which show how the digital experience score changes over time; and heat maps, which highlight areas with poor performance that require intervention.

User feedback and continuous monitoring are integral to refining the digital experience score calculation process. Feedback mechanisms allow users to provide input on the accuracy and relevance of the scores, which can be used to adjust the weighting and analysis methods. Continuous improvement ensures that the digital experience scores remain accurate and reflective of actual user experiences.

Calculating digital experience scores involves a multi-step process that includes data collection, aggregation, normalization, analysis, weighting, and real-time updates. By integrating various performance metrics and using sophisticated methods, digital experience scores provide a quantifiable measure of user experience. These scores help IT teams monitor and optimize digital environments, ensuring a high-quality user experience and facilitating proactive issue resolution.

### § 6.0 Automated Reasoning and Explanation

Digital experience monitoring systems, such as Zscaler Digital Experience (ZDX), are designed to track a variety of critical metrics including network latency, application performance, device health, and user behavior to assess and gauge user experience comprehensively. Traditional methods for analyzing these metrics often employ machine learning algorithms to identify correlations and patterns, but pinpointing the exact root causes of performance issues typically necessitates human expertise. This manual interpretation process can be both time-consuming and inconsistent, as it relies heavily on the skill and experience of individual analysts.

In contrast, the present disclosure presents an approach that leverages the capabilities of Large Language Models (LLMs) to automate the interpretation of these correlations. By integrating LLMs into the monitoring system, it becomes possible to generate explanations for performance issues in real-time. This automation not only enhances the reliability and scalability of insights provided but also significantly improves the efficiency of digital experience monitoring. The system's ability to deliver immediate, accurate interpretations of complex data correlations frees up human experts to focus on more strategic tasks, leading to a more streamlined and effective monitoring process.

Understanding user experience in digital environments requires analyzing a variety of factors that interact in complex and often unpredictable ways. For example, an increase in Page Fetch Time (PFT) might be associated with network delays, but determining the exact cause of these delays can be challenging. While machine learning models are adept at identifying correlations between various metrics, the task of interpreting these correlations has traditionally fallen to human experts. This reliance on human analysis is not easily scalable and can lead to inconsistent conclusions, as the interpretation can vary significantly depending on the expertise and perspective of the individual analyst.

This invention seeks to bridge this gap by leveraging LLMs to automate the interpretation process. Instead of depending on human experts to decipher the data, the system utilizes LLMs to generate explanations automatically. This approach ensures more consistent and reliable insights while minimizing the need for manual intervention. By automating the interpretation of complex data interactions, the system enables IT administrators and companies to monitor and optimize user experience with greater efficiency and accuracy. This not only streamlines the process but also allows for a more scalable solution, ultimately enhancing the overall management of digital environments.

The central concept of this invention is to utilize LLMs to automate the reasoning process involved in correlating factors within digital experience monitoring. Machine learning models first detect correlations, such as a relationship between slow application response times and high network latency. Once these correlations are identified, the LLM steps in to process this data and generate a coherent explanation. Drawing from its extensive training on a vast array of technical and domain-specific information, the LLM can connect the dots, providing a plausible and insightful reason for the observed correlations.

This system offers tenants of the cloud 120 the advantage of expert-level analysis without the need for human intervention at every stage. It is scalable and ensures consistent quality in the explanations provided. Additionally, the system is adaptable, as it can improve its reasoning capabilities over time based on feedback and continuous learning. By automating the interpretation of complex data interactions, the invention allows for more efficient and accurate monitoring and optimization of user experience, ultimately enhancing the overall management of digital environments. This innovative approach not only streamlines the analysis process but also ensures that insights are reliable and scalable, providing significant value to IT administrators and businesses.

The digital experience monitoring system begins by collecting comprehensive data on various factors that impact user experience. These factors include, but are not limited to, network speed, application performance, device metrics, user behavior, and the like. The data collection process is robust, ensuring that all relevant information is captured to provide a holistic view of the digital environment. Advanced machine learning techniques, such as time series analysis and Random Cut Forests (RCF), are then employed to identify correlations within this data and to detect any anomalies that fall outside of “normal” ranges. These techniques can detect patterns and anomalies in real-time or through batch processing, depending on the specific requirements and context of the analysis.

Once the machine learning models have identified anomalies and correlations, the next step involves integrating this information with LLMs. The detected anomalies and correlations are fed into the LLM, which is extensively trained on a vast repository of both general and domain-specific data. This extensive training allows the LLM to reason about the correlations effectively. For instance, if a correlation between network latency and CPU usage is detected, the LLM might conclude that a high CPU load is causing delays in data processing, which in turn affects network performance. This reasoning process leverages the LLM's deep knowledge base to provide insightful explanations.

The process of feeding the information to the LLM includes automatically generating a prompt for the LLM. This includes populating dynamic portions of a prompt with the detected anomalies and correlations in a way that allows the LLM to understand the data and anomalies.

The final step involves the LLM generating clear and coherent explanations based on the detected correlations. These explanations are designed to be easily understandable, even for those without technical expertise. By automating the reasoning process, the LLM essentially takes on the role of a human analyst, connecting the dots between the correlated factors and providing plausible root causes for observed issues. This automated approach ensures consistency in the analysis and significantly reduces the need for manual intervention. The generated explanations help IT administrators and companies quickly understand and address performance issues, leading to more efficient and effective digital experience monitoring and optimization.

In order to generate such an explanation, the system is adapted to provide an input/prompt to the LLM. In various embodiments, this prompt includes one or more static portions that are unchanged based on the scenario, and a dynamic potion. In an example, the static portion of the prompt can state “You are an expert IT administrator. Here's what was observed on an employee's laptop: . . . What could be the issue? List the top 3 possible causes.” Further, the dynamic portion can include the various data points collected by the ZDX system, i.e., what was observed on the employee's laptop and what did the machine learning models extract as important information. An example prompt generated by the present system can include the following.
You are an expert IT administrator. Here's what was observed on an employee's laptop:
   1. Users'ZDX score dropped in the last 2 hours.
   2. TCP handshake times occasionally spike above 1 second.
   3. Wi-Fi signal strength decreased to 50%.
   4. Access point latency spiked to 150 ms.
What could be the issue? List the top 3 possible causes.

Based thereon, the LLM is adapted to generate the explanation. Based on the described example, the explanation can include the following.
1. Physical obstruction or increased distance from access point:
   Explanation: a 50% decrease in Wi-Fi strength and a spike in access point latency suggests that the laptop may have been moved further from the Wi-Fi access point or there are new physical obstructions (e.g., walls, furniture) impeding the signal.
   Impact: reduced signal strength leads to higher latency and slower network performance causing TCP handshake times to spike and the ZDX score to drop.
2. Wi-fi interference from other device or network:
   Explanation: interference from other electronic devices or overlapping Wi-Fi networks on the same channel can degrade signal quality.
   Impact: Interference can cause fluctuations in signal strength and latency, leading to intermittent spikes in TCP handshake times and a decline in overall network experience.
3. Hardware issues with the Wi-Fi adapter or access point:
   Explanation: a malfunctioning Wi-Fi adapter in the laptop or issues with the access point can cause connectivity problems.
   Impact: hardware issues can lead to inconsistent signal reception and transmission errors, resulting in increased latency, poor network performance, and a lower ZDX score.

By integrating LLMs into the ZDX platform, the invention not only enhances the accuracy and reliability of performance monitoring but also ensures that insights are scalable and adaptable. This innovative approach transforms the traditional methods of digital experience analysis, providing consistent, expert-level explanations that continuously improve over time.

The explanations generated by the LLMs are presented to users through a user-friendly and intuitive interface. This interface is designed to facilitate easy interaction, allowing operators to engage with the system seamlessly. The visual presentation of the explanations ensures that even complex technical insights are accessible and understandable to a broad range of users, including those without deep technical expertise.

A critical feature of this interface is its interactive feedback mechanism. Users can provide feedback on the explanations they receive, offering insights into the accuracy and relevance of the information presented. This feedback is invaluable as it helps the system refine its reasoning process over time. By learning from user feedback, the LLM can improve its ability to generate more accurate and contextually appropriate explanations in the future.

The feedback mechanism operates in a continuous loop, where each piece of user input contributes to the ongoing enhancement of the system's analytical capabilities. This iterative process ensures that the explanations become increasingly reliable and tailored to the specific needs and contexts of the users. Furthermore, the system's adaptability allows it to evolve alongside changing digital environments and emerging issues, maintaining its effectiveness and relevance over time.

Overall, the user interface and feedback mechanism not only make the system more accessible and user-friendly but also drive the continuous improvement of its reasoning and explanatory functions. This dynamic interaction between users and the system fosters a collaborative approach to digital experience monitoring, where human insights and machine intelligence work together to optimize performance and user satisfaction.

### § 6.1 Automated Reasoning and Explanation

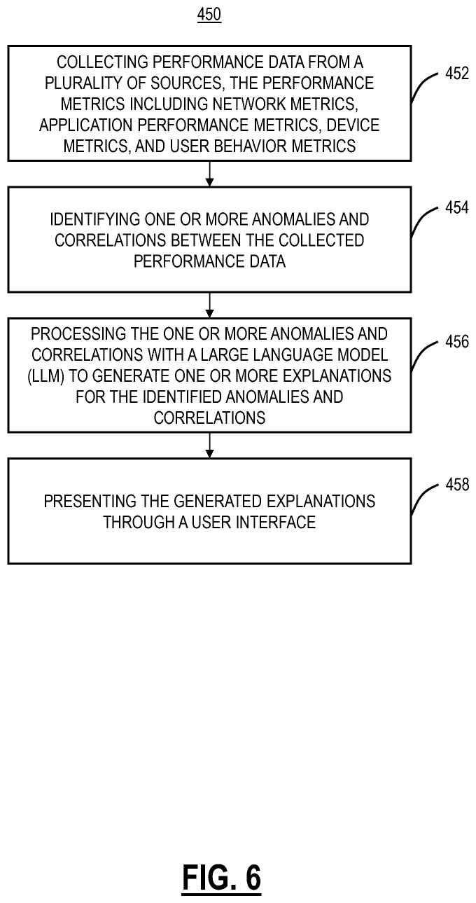

FIG. 6 is a flowchart of a process 450 for automated reasoning and explanation of correlated factors in digital experience monitoring. In various embodiments, the process 450 can be contemplated as a method having steps, a processing device configured to implement the steps, a cloud-based system configured to implement the steps, and as a non-transitory computer-readable medium storing instructions for programming one or more processors to execute the steps. The process 450 includes collecting performance data from a plurality of sources, the performance metrics including network metrics, application performance metrics, device metrics, and user behavior metrics (step 452); identifying one or more anomalies and correlations between the collected performance data (step 454); processing the one or more anomalies and correlations with a Large Language Model (LLM) to generate one or more explanations for the identified anomalies and correlations (step 456); and presenting the generated explanations through a user interface (step 458).

The process 450 can further include wherein collecting performance data includes collecting real-time performance data. The performance data can be collected from any of the cloud-based system, endpoint devices, and applications. The LLM can be trained on a dataset that includes both general information and domain-specific technical data. The steps can include generating a prompt based on the one or more anomalies and correlations. The prompt can include a static portion and a dynamic portion, wherein the dynamic portion is automatically populated based on the one or more anomalies and correlations. The steps can include receiving user feedback on the generated explanations and using the feedback to refine the LLM.

### § 7.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 8.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method implemented by a cloud-based system, the method comprising steps of:
collecting performance data from a plurality of sources, the performance data including network metrics, application performance metrics, device metrics, and user behavior metrics;
identifying one or more anomalies and correlations between the collected performance data;
processing the one or more anomalies and correlations with a Large Language Model (LLM) to generate one or more explanations for the identified anomalies and correlations; and
presenting the generated explanations through a user interface.

2. The method of claim 1, wherein collecting performance data includes collecting real-time performance data.

3. The method of claim 1, wherein the performance data is collected from any of the cloud-based system, endpoint devices, and applications.

4. The method of claim 1, wherein the LLM is trained on a dataset that includes both general information and domain-specific technical data.

5. The method of claim 1, wherein the steps include generating a prompt based on the one or more anomalies and correlations.

6. The method of claim 5, wherein the prompt includes a static portion and a dynamic portion, wherein the dynamic portion is automatically populated based on the one or more anomalies and correlations.

7. The method of claim 1, wherein the steps include receiving user feedback on the generated explanations and using the feedback to refine the LLM.

8. A non-transitory computer-readable medium comprising instructions that, when executed, cause one or more processors of a cloud-based system to perform steps of:
collecting performance data from a plurality of sources, the performance data including network metrics, application performance metrics, device metrics, and user behavior metrics;
identifying one or more anomalies and correlations between the collected performance data;
processing the one or more anomalies and correlations with a Large Language Model (LLM) to generate one or more explanations for the identified anomalies and correlations; and
presenting the generated explanations through a user interface.

9. The non-transitory computer-readable medium of claim 8, wherein collecting performance data includes collecting real-time performance data.

10. The non-transitory computer-readable medium of claim 8, wherein the performance data is collected from any of the cloud-based system, endpoint devices, and applications.

11. The non-transitory computer-readable medium of claim 8, wherein the LLM is trained on a dataset that includes both general information and domain-specific technical data.

12. The non-transitory computer-readable medium of claim 8, wherein the steps include generating a prompt based on the one or more anomalies and correlations.

13. The non-transitory computer-readable medium of claim 12, wherein the prompt includes a static portion and a dynamic portion, wherein the dynamic portion is automatically populated based on the one or more anomalies and correlations.

14. The non-transitory computer-readable medium of claim 8, wherein the steps include receiving user feedback on the generated explanations and using the feedback to refine the LLM.

15. A cloud-based system comprising:
one or more processors; and
memory storing computer-executable instructions that, when executed, cause the one or more processors to:
collect performance data from a plurality of sources, the performance data including network metrics, application performance metrics, device metrics, and user behavior metrics;
identify one or more anomalies and correlations between the collected performance data;
process the one or more anomalies and correlations with a Large Language Model (LLM) to generate one or more explanations for the identified anomalies and correlations; and
present the generated explanations through a user interface.

16. The cloud-based system of claim 15, wherein collecting performance data includes collecting real-time performance data.

17. The cloud-based system of claim 15, wherein the performance data is collected from any of the cloud-based system, endpoint devices, and applications.

18. The cloud-based system of claim 15, wherein the LLM is trained on a dataset that includes both general information and domain-specific technical data.

19. The cloud-based system of claim 15, wherein the instructions, when executed, cause the one or more processors to generate a prompt based on the one or more anomalies and correlations.

20. The cloud-based system of claim 19, wherein the prompt includes a static portion and a dynamic portion, wherein the dynamic portion is automatically populated based on the one or more anomalies and correlations.
